(19) United States
(12) Patent Application Publication
(10) Pub. No.: US 2007/0067499 A1
(43) Pub. Date: Mar. 22, 2007

(54) Systems and methods for satellite payload application development

(75) Inventors: Jeffrey M. Wolfe, Parrish, FL (US); Jason L. Copenhaver, Sarasota, FL (US); Jeremy Ramos, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/222,213

(22) Filed: Sep. 8, 2005

(51) Int. Cl. G06F 3/00

(52) U.S. Cl. 710/1

(57) ABSTRACT

System and methods for satellite payload application development are provided. A method for developing embedded processing systems comprises selecting a hardware layer configuration; and developing an interfacing software stack providing services from one or more of an infrastructure services layer, a bus abstraction layer, a device abstraction layer, and a peripheral device driver layer through one or more standard function calls.

### TECHNICAL FIELD

The present invention generally relates to computer systems and more specifically to the design of payload applications for satellites.

### BACKGROUND

Payload applications for satellites are usually developed from scratch. Each payload application requires the development and incorporation of new infrastructure software that coordinates a payload application with satellite hardware physical layers and operating systems. One problem that arises with this design process is that changes in the physical hardware layer often occur late in the development cycle, often requiring significant code modifications to each payload application. For example, the replacement of one vendor's communication board with another vendor's communication board, or a change from one system bus architecture to another, in the hardware layer can require a considerable rewriting of code for each payload application that utilizes the communication board. In order to avoid such extensive payload application code rewrites late in the development cycle, satellite development teams often commit themselves to lock-in to technologies very early in the design cycle, thus forgoing opportunities to use superior hardware technologies that might become available prior to deployment of the satellite.

For the reasons stated above and for other reasons stated below which will become apparent to those skilled in the art upon reading and understanding the specification, there is a need in the art for improved systems and methods for satellite payload application development.

### SUMMARY

The Embodiments of the present invention provide methods and systems for the developing of payload applications for satellites and will be understood by reading and studying the following specification.

In one embodiment, an embedded computer processing system is provided. The system comprises a processor adapted to execute one or more payload software applications; at least one system bus coupled to the processor; and at least one hardware device coupled to the at least one system bus. The processor is further adapted to execute an interfacing software stack, wherein the one or more payload applications communicate data with the at least one hardware device by communicating with the software interface stack. The interfacing software stack includes a peripheral device driver layer responsive to the one or more payload software applications. The interfacing software stack further includes a device abstraction layer responsive to one or both of the one or more payload software applications and the peripheral device driver layer. The interfacing software stack further includes a bus abstraction layer responsive to one or more of the device abstraction layer, the one or more payload software applications and the peripheral device driver layer. The interfacing software stack further includes an infrastructure services layer responsive to one or more of the bus abstraction layer, the device abstraction layer, the one or more payload software applications and the peripheral device driver layer.

In another embodiment, a method for developing embedded processing systems is provided. The method comprises selecting a hardware layer configuration; and developing an interfacing software stack providing services from one or more of an infrastructure services layer, a bus abstraction layer, a device abstraction layer, and a peripheral device driver layer through one or more standard function calls.

In yet another embodiment, an interfacing software stack for embedded payload applications is provided. The software interface stack comprises a peripheral device driver layer responsive to one or more function calls from one or more payload software applications; a device abstraction layer responsive to one or more function calls from one or both of the one or more payload software applications and the peripheral device driver layer; a bus abstraction layer responsive to one or more function calls from one or more of the device abstraction layer, the one or more payload software applications and the peripheral device driver layer; and an infrastructure services layer responsive to one or more function calls from one or more of the bus abstraction layer, the device abstraction layer, the one or more payload software applications and the peripheral device driver layer.

### DRAWINGS

Embodiments of the present invention can be more easily understood and further advantages and uses thereof more readily apparent, when considered in view of the description of the embodiments and the following figures in which:

FIG. 1 is an illustration of a satellite processing system hardware layer of one embodiment of the present invention;

FIG. 2A is a diagram of an interfacing software stack of one embodiment of the present invention;

FIG. 2B is a diagram illustrating peripheral device drivers of an interfacing software stack of one embodiment of the present invention;

FIG. 3 is a flow chart depicting a method of one embodiment of the present invention; and

FIG. 4 is a flow chart illustrating a method of another embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

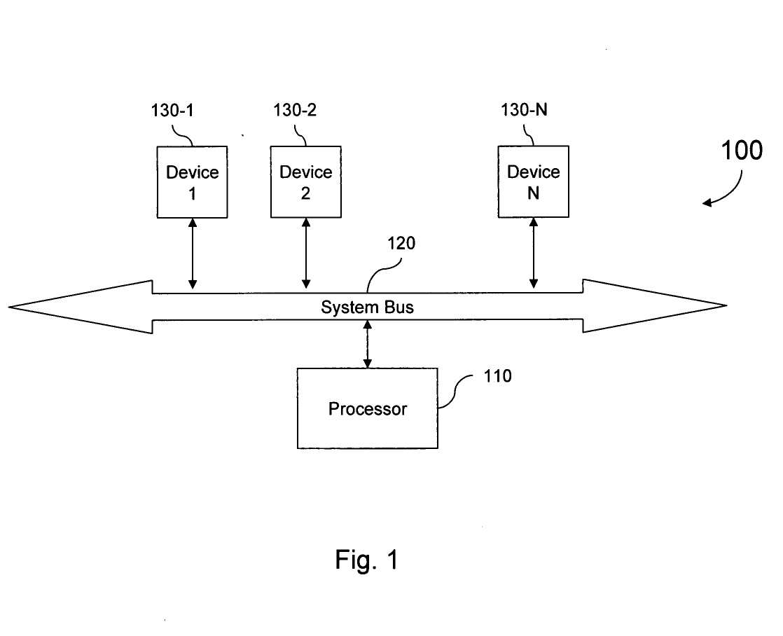

FIG. 1 illustrates a typical physical hardware layer 100 of a satellite computer platform of one embodiment of the present invention. In one embodiment, hardware layer 100 comprises at least one processor 110 running an operating system (O/S) 115, coupled to at least one system bus 120, and one or more hardware devices 130-1 to 130-N coupled to system bus 120. In operation, one or more payload applications 150 executed by processor 110 share data with hardware devices 130-1 to 130-N by communicating through the at least one system bus 120.

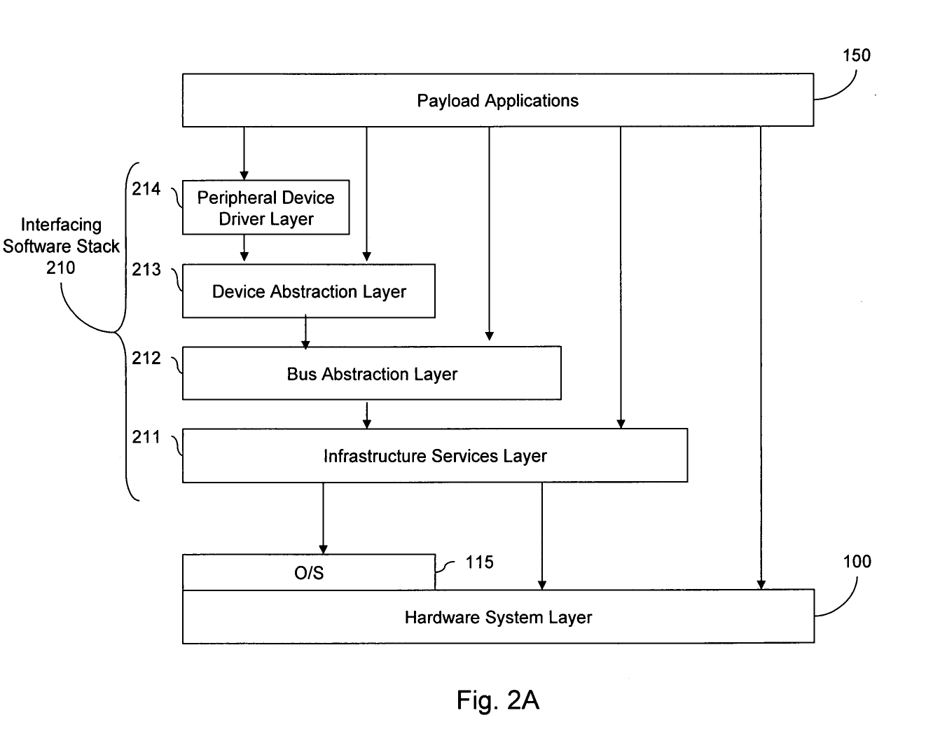

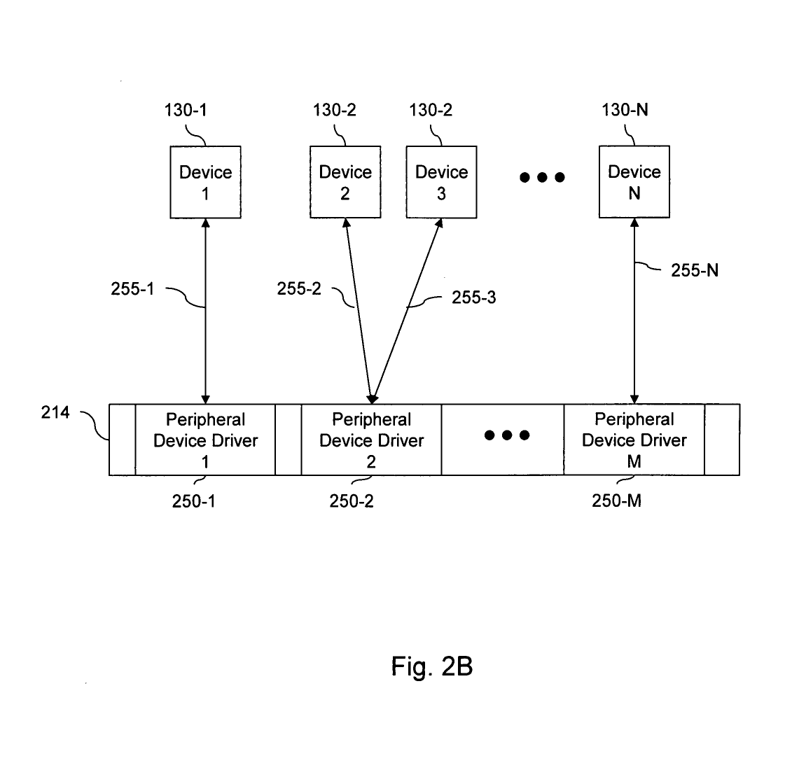

Embodiments of the present invention provide a way to manage devices in a more portable way so that they are nearly independent of the bus, processor, and operating system to which they are attached. Embodiments of the present invention eliminate the need for payload applications 150 to include code customized to accommodate hardware layer 100 by providing a functionally modularized interfacing software stack 210, as illustrated in FIG. 2A. Interfacing software stack 210 comprises multiple software layers, discussed below, that each provide hardware related service via standard function calls to enable payload applications 150 to communicate with hardware devices 130-1 to 130-N. Embedding these functions within the layers of interfacing software stack 210, relieves the need to include such code within payload applications 150. Instead, development of payload applications 150 need only include the function calls defined within interfacing software stack 210 to obtain the services of devices 130-1 to 130-N required to perform payload applications' 150 mission. For this reason, embodiments of the present invention enable the coding of payload applications to begin earlier in a satellite project's development cycle, thereby reducing payload application development time, and reduce payload application development dependence on a static underlying hardware platform. Although examples of embodiments of the present invention illustrated in this application describe payload applications executed on space-based systems, one skilled in the art upon reading this specification would appreciate that the scope of present invention is not limited to space-based systems, but that embodiments encompass any embedded computing system.

In one embodiment, interfacing software stack 210 comprises an infrastructure services layer 211, a bus abstraction layer 212, a device abstraction layer 213, and a layer of one or more peripheral device drivers 214. Each layer of interfacing software stack 210 compartmentalizes key functions required for payload applications 150 to communicate with, and in some embodiments control, one of hardware devices 130-1 to 130-N. Each of the layers of interfacing software stack 210 is discussed in detail below.

In one embodiment, infrastructure services layer 211 provides low level functional support to payload applications 150, system bus abstraction layer 212, device abstraction layer 213, and peripheral device driver layer 214. The services provided by infrastructure services layer 211 are those infrastructure services that are typically necessary regardless of the hardware implementation (e.g. the processor 110 chipsets or system bus 120 architecture) used. The infrastructure services provided by infrastructure services layer 211 include, but are not limited to, error handling, exception mechanisms, diagnostics, event and error logging, threading, thread protection and mutual exclusion mechanisms. In one embodiment, infrastructure services layer 211 further includes typical O/S services extracted from O/S 115. When higher level layers require infrastructure services, they are accessed from the infrastructure services layer 211 through one or more standardized function calls.

A large variety of system bus 120 architectures are currently available for satellite developers to include in designing hardware layer 100. Current system bus technologies include, but are not limited to, peripheral component interconnect (PCI), modular bus, Rapid I/O and Space-Wire. Bus abstraction layer 212 provides payload applications 150, device abstraction layer 213, and device driver layer 214 with the necessary bus service functions to interface with, and communicate via a system bus 120. Through standardized function calls, bus abstraction layer 212 provides those bus services which are generic to the particular architecture of system bus 120. In one embodiment, the bus service functions provided by bus abstraction layer 212 include, but is not limited to, bus initialization, bus hardware query and bus discovery services. For example, in one embodiment, bus abstraction layer 212 supports a PCI system bus architecture. Bus abstraction layer 212 would then provide higher level layers those bus services which are generic to all PCI architectures.

Device abstraction layer 213 provides payload applications 150 and peripheral device driver layer 214 with necessary device management services to communicate with devices 130-1 to 130-N. In one embodiment, necessary device management services include standard functions such as managing device initializations, sessions, mutual exclusion of devices, and device discovery. Device abstraction layer 213 relieves payload applications 150 and peripheral device driver layer 214 from the need to know where in hardware layer 100 a particular hardware device is installed, what type of system bus architecture is being used, how to establish a session with the device, and how to maintain the session and session related states. Further, the dialog between device abstraction layer 213 and the higher level layers utilizes standardized function calls that are independent of the underlying specifications of hardware layer 100. The highest layer of interfacing software stack 210 is a peripheral device driver layer 214. In one embodiment, hardware devices 130-1 to 130-N include one or more of, but not limited to data input devices (e.g., environmental sensors, image capturing devices), output devices (e.g., monitors, printers), data storage devices (e.g., disk or tape drives, memory devices), communication devices (e.g. wireless communication devices, network adapters), mechanical device controller (e.g. controllers for motors, servos, solenoids, lighting, heaters), or any other device that provides services which expand the functional abilities of the system. As illustrated in FIG. 2B, for each type of hardware device 130-1 to 130-N installed in the physical hardware layer 100, peripheral device driver layer 214 comprises an associated peripheral device driver 250-1 to 250-M (associations illustrated by 255-1 to 255-N) which allows payload applications 150 to access the specialized services of the specific hardware devices. In operation, when a payload application 150 needs to access the services of a target device (such as device 130-1), the payload application 150 calls on a specific function provided by a peripheral device driver (such as peripheral device driver 250-1) associated with device 130-1. In some embodiments, a single hardware device (such as hardware device 130-1) is associated with a single peripheral device driver (such as peripheral device driver 250-1). Any payload application 150 requiring services from hardware device 130-1 accesses those services through one or more function calls provided by peripheral device driver 250-1. For example, in one embodiment where device 130-1 is an imagery sensor, the specialized services may include capturing image data. The function calls provided by peripheral device driver 250-1 are accordingly dedicated to providing functions such as setting frame capture rates, frame resolution, lens focusing, camera positioning, and initiating an image capture. In some embodiments, where two or more of hardware devices 130-1 to 130-N provide the same services to the system (such as hardware devices 130-2 and 130-3) a single peripheral device driver (such as peripheral device driver 250-2) is associated with the two or more hardware devices 130-1 to 130-N. In one embodiment, a payload application specifies which of hardware devices 130-1 and 130-2 to communicate with by specifying one or more parameters in the function call.

In one embodiment, when a payload application 150 requires the services of target device 130-1 (e.g., to capture an image), payload application 150 calls on standard function call provided by associated peripheral device driver 250-1 and located within peripheral device driver layer 214. The associated peripheral device driver in turn requests device abstraction layer 213 to establish a communication session between peripheral device driver layer 214 and target device 130-1.

In one embodiment, device abstraction layer 213 knows which system bus target device 130-1 is located on, and the bus architecture utilized by that system bus. For example, in one embodiment, device abstraction layer 213 knows that target device 130-1 is located on system bus 120 and that system bus 120 is a PCI bus. In one embodiment, device abstraction layer 213 is programmed to discover system bus 120's architecture and determine what devices are installed on system bus 120. In one embodiment, one or both of the architecture of system bus 120 and the installation of devices 130-1 to 130-N are coded into device abstraction layer 213. Once device abstraction layer 213 identifies the location of target device 130-1 on system bus 120, device abstraction layer 213 directs a request for initialization of system bus 120 to bus abstraction layer 212.

In one embodiment, upon request from a peripheral device driver 214, device abstraction layer 213 requests initialization of system bus 120 through bus services provided by bus abstraction layer 212, establishes a session between device 130-1 and the associated peripheral device driver 250-1 to 250-M in peripheral device driver layer 214, and maintains related session states for as long as payload application 150 requires access to device 130-1. In one embodiment, device abstraction layer 213 manages the exclusive use of device 130-1 for payload application 150, and prevents other applications from accessing device 130-1 while the session is open.

With embodiments of the present invention, it is no longer necessary for payload application developers to code their own software with functions for locating associated devices, identifying and initializing system buses, establishing sessions and managing session states, because these functions have been incorporated into bus abstraction layer 212 and device abstraction layer 213 as described above. In addition, basic services such as error handling, exception mechanisms, diagnostics, logging, threading, and thread protection are provided by infrastructure services layer 211. This allows the coding of a payload application to concentrate on the interface with the device drivers of peripheral device driver layer 214 to utilize the functions provided by an associated device 130-1 to 130-N. The interfacing software stack of the present invention relieves developers of payload applications 150 from the need to know where particular hardware devices are installed, what type of system bus architecture is used, how to establish a session with the devices, and how to maintain sessions and session related states.

As illustrated in FIG. 2A, interfacing software stack 210, enables payload applications 150 to access services provided by hardware devices 130-1 to 130-N purely through function calls provided by peripheral device driver layer 214 and without the need to directly communicate with hardware system layer 100. However, the staircase nature of interfacing software stack 210 layers does not prevent such direct access. Interfacing software stack 210 enables payload application 150 to directly access any service provided by hardware system layer 100. Further, embodiments of the present invention provide payload application developers the option of bypassing any one or more of layers 211-214 of interfacing software stack 210 by directly executing a function call to any of the layers 211-214. For example, application developers may choose to incorporate their own proprietary device driver function calls within their payload application and code the application to make function calls to device abstraction layer 213 directly. Similarly, any one of layers 211-214 may be coded to bypass functions provided by one or more of the other layers 211-214 either by directly executing a function call provided by any layer 211-214, or by directly communicating with hardware system layer 100.

Embodiments of the present invention also enable both developers of payload applications and vendors of satellite systems to establish and utilize a library of standardized function code for developing their respective software. For example, the developer of a payload application utilizing the services of hardware device 130-1 may develop an internal subroutine containing the standardized function calls provided by associated peripheral device driver 250-1. In the future, the developer may simply reuse the code for that subroutine in other payload applications they develop for satellite systems using the same hardware device 130-1. In this fashion, payload application developers can build and maintain a library of subroutines for hardware devices they routinely utilize. Additionally, by relying on the standardized function calls provided by a peripheral device driver, payload application developers are insulated from the need to recode their application should a satellite system vendor alter hardware specifications, such as the system bus architecture.

In the same way, because of the modular design and standardized function calls of the abstractive infrastructure layer, embodiments of the present invention further allow satellite system vendors to reuse code developed and tested for layers 211-214 from previous projects when building an abstractive infrastructure layer for a specific project. For example a satellite system vendor may establish and utilize a library of infrastructure services layer codes for various combinations of O/S and processors. A library of previously used and tested code may be similarly established for peripheral device drivers, device abstraction layers, and bus abstraction layers. The use of standardized function calls enables the interoperability of layers selected from the library without the need for significant recoding of the layers for the specific project.

Embodiments of the present invention also allow satellite system vendor to create peripheral device drivers earlier in the development cycle (as soon the decision to use the device in the hardware layer is made) without the fear of having to necessarily create entirely new peripheral device drivers if changes in processor, operating system, or system bus architectures are later required. In fact, embodiments of the present invention allow development of peripheral device drivers without knowledge of the underlying processor core, operating system, or system bus architectures.

When a satellite system vendor decides to replace one or more of hardware devices 130-1 to 103-N manufactured by one vendor with devices providing the same primary function, but manufactured by different vendors, embodiments of the present invention allow developers to appropriately replace the associated peripheral device driver in peripheral device driver layer 214 without the need to recode the entirety of interfacing software stack 210. In the same way each layer of interfacing software stack localizes the software changes required due to changes in system hardware 100 specifications.

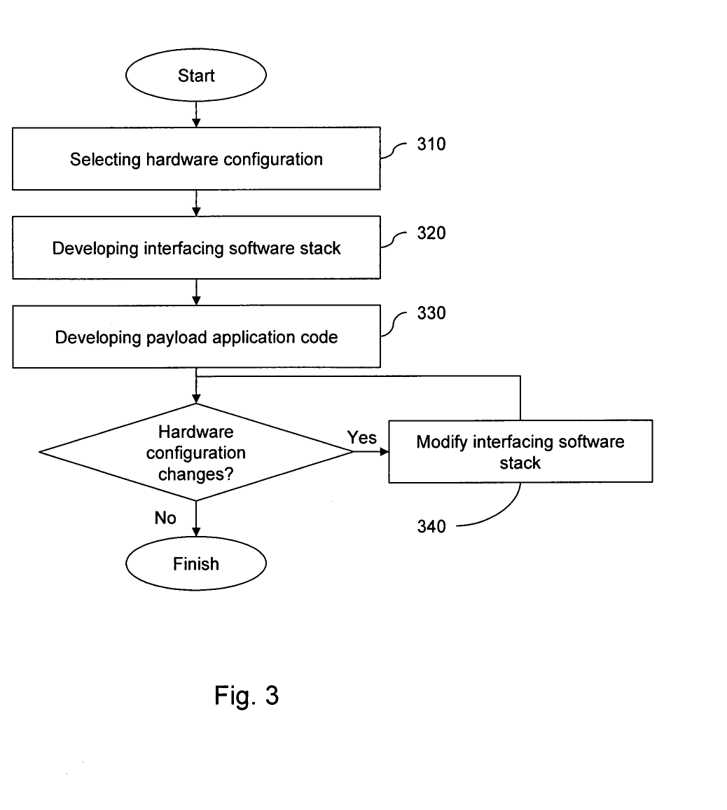

FIG. 3 is a flow chart illustrating a method for developing satellite payload applications of one embodiment of the present invention. The method begins at 310 with selecting a hardware configuration for a hardware layer of a satellite. In one embodiment, selecting a hardware configuration comprises selecting a processor, selecting an operating system, selecting one or more peripheral hardware devices, and selecting at least one system bus between the processor and the one or more hardware devices. In one embodiment, the one or more peripheral hardware devices each provide specialized functions such as, but not limited to, communications transmitting and receiving, data storage, sensing (e.g., capturing image, sound, temperatures, pressures, radiation levels, or other environmental factors), or mechanical manipulations (e.g., electrically controlled motors, pumps, valves, servos). In one embodiment, the at least one system bus comprises an industry standard system bus, such as, but not limited to a PCI bus, a modular bus, a Rapid I/O bus and a space-wire bus. In one embodiment, the processor comprises one or more processing cores.

The method continues at 320 with developing an interfacing software stack that provides standardized functions to payload applications compartmentalized into software layers comprising one or more of infrastructure services, bus services, device management services and peripheral device drivers associated with the one or more hardware devices. In one embodiment, the one or more payload applications communicate with the interfacing software stack through one or more standard function calls associated with the standardized functions. In one embodiment the peripheral device drivers provide payload applications with standard function calls for accessing the one or more specialized functions of the at least one hardware device. In one embodiment, infrastructure services includes providing one or more of, error handling, exception handling, diagnostics, logging, threading, thread protection and mutual exclusion services. In one embodiment, providing bus services for the at least one system bus includes providing one or more of system bus initialization, system bus query services, and system bus discovery services. In one embodiment, providing device management services includes providing one or more of managing device initializations, managing communication sessions, mutual device exclusion services, and device discovery. The method continues at 330 with developing the payload application code. In one embodiment, the payload application code is designed to access functions and services provided by the layers of the interfacing software stack in order to communicate data with the underlying hardware layer. Accessing the hardware layer though interfacing software stack function calls significantly insulates payload applications from the need to be recoded when changes are made in hardware layer specifications. As illustrated by FIG. 3, when a satellite vendor changes one or more hardware specification, the interfacing software stack is modified to accommodate the change (340). For example, if a hardware device is relocated from one system bus to another system bus, or if a system bus architecture used for one system bus is replaced with a different system bus architecture, one or more layers of the interfacing software stack may need to be modified because of the configuration change. However, in one embodiment, the payload application code will not need additional modification to continue to access hardware devices as long as the function calls provided by the peripheral device drivers remain the same.

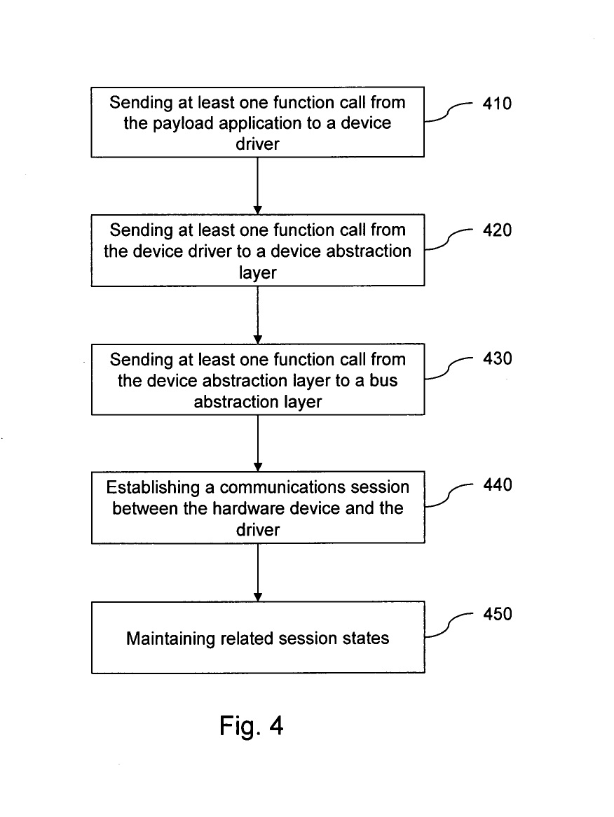

FIG. 4 is a flow chart illustrating a method for communicating data between a satellite payload application and a hardware device in a satellite system hardware layer. The method begins at 410 with sending at least one function call from the payload application to a peripheral device driver associated with the hardware device. In one embodiment, the function call request identifies which one of a plurality of hardware devices the payload application needs to communicate with. The method continues at 420 with sending at least one function call from the peripheral device driver to a device abstraction layer to establish a communications session between the peripheral device driver and the hardware device. As discussed with respect to FIG. 2, the device abstraction layer knows which of one or more system busses couple a processor executing the payload application with the hardware device. The method continues at 430 with sending at least one function call from the device abstraction layer to a bus abstraction layer requesting initialization of the system bus coupled to the hardware device. The method next proceed to 440 with establishing a communications session between the hardware device and the driver, and maintaining related session states (450) for as long as the payload application requires access to the hardware device.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An embedded computer processing system, the system comprising:
a processor adapted to execute one or more payload software applications;
at least one system bus coupled to the processor; and
at least one hardware device coupled to the at least one system bus;
wherein, the processor is further adapted to execute an interfacing software stack, wherein the one or more payload applications communicate data with the at least one hardware device by communicating with the software interface stack;
wherein the interfacing software stack includes a peripheral device driver layer responsive to the one or more payload software applications;
wherein the interfacing software stack further includes a device abstraction layer responsive to one or both of the one or more payload software applications and the peripheral device driver layer;
wherein the interfacing software stack further includes a bus abstraction layer responsive to one or more of the device abstraction layer, the one or more payload software applications and the peripheral device driver layer; and
wherein the interfacing software stack further includes an infrastructure services layer responsive to one or more of the bus abstraction layer, the device abstraction layer, the one or more payload software applications and the peripheral device driver layer.

2. The system of claim 1, wherein the infrastructure services layer is adapted to provide infrastructure services including one or more of, error handling, exception handling, diagnostics, logging, threading, thread protection and mutual exclusion services.

3. The system of claim 1, wherein the bus abstraction layer is adapted to provide bus services for the at least one system bus including one or more of system bus initialization, system bus query services, system bus discovery services.

4. The system of claim 1, wherein the device abstraction layer is adapted to provide device management services for the at least one hardware device including one or more of managing device initializations, managing communication sessions, mutual device exclusion services, and device discovery.

5. The system of claim 1, wherein the peripheral device driver layer includes an associated peripheral device driver for each of the at least one hardware device, wherein the associated peripheral device driver is adapted to provide one or more specialized services of the at least one hardware device to the one or more payload software applications.

6. The system of claim 1, wherein the one or more of the payload applications, the peripheral device driver layer, the device abstraction layer, the bus abstraction layer, and infrastructure services layer, communicating through one or more standard function calls.

7. An interfacing software stack for embedded payload applications, the software interface stack comprising:
a peripheral device driver layer responsive to one or more function calls from one or more payload software applications;
a device abstraction layer responsive to one or more function calls from one or both of the one or more payload software applications and the peripheral device driver layer;
a bus abstraction layer responsive to one or more function calls from one or more of the device abstraction layer, the one or more payload software applications and the peripheral device driver layer; and
an infrastructure services layer responsive to one or more function calls from one or more of the bus abstraction layer, the device abstraction layer, the one or more payload software applications and the peripheral device driver layer.

8. The software interface stack of claim 7, wherein the infrastructure services layer is adapted to provide infrastructure services including one or more of, error handling, exception handling, diagnostics, logging, threading, thread protection and mutual exclusion services.

9. The software interface stack of claim 7, wherein the bus abstraction layer is adapted to provide bus services for the at least one system bus including one or more of system bus initialization, system bus query services, system bus discovery services.

10. The software interface stack of claim 7, wherein the device abstraction layer is adapted to provide device management services for the at least one hardware device including one or more of managing device initializations, managing communication sessions, mutual device exclusion services, and device discovery.

11. The software interface stack of claim 7, wherein the peripheral device driver layer includes an associated peripheral device driver for each of the at least one hardware device, wherein the associated peripheral device driver is adapted to provide one or more specialized services of the at least one hardware device to the one or more payload software applications.

12. A method for developing embedded processing systems, the method comprising:
selecting a hardware layer configuration; and
developing an interfacing software stack providing services from one or more of an infrastructure services layer, a bus abstraction layer, a device abstraction layer, and a peripheral device driver layer through one or more standard function calls.

13. The method of claim 12, further comprising:
developing a payload application code that accesses one or more services of the infrastructure services layer, the bus abstraction layer, the device abstraction layer, and the peripheral device driver layer through the one or more standard function calls.

14. The method of claim 13, wherein developing a payload application code comprises selecting one or more subroutines for calling the one or more standard function calls from a collection of previously used subroutines.

15. The method of claim 12, wherein when one or more modification are made to the hardware configuration, the method further comprises:
modifying one or more of the infrastructure services layer, the bus abstraction layer, the device abstraction layer, and the peripheral device driver layer.

16. The method of claim 12, wherein developing an interfacing software stack comprises selecting software code for one or more of the infrastructure services layer, the bus abstraction layer, the device abstraction layer, and the peripheral device driver layer from a collection of previously used subroutines.

17. The method of claim 12, wherein selecting a hardware configuration further comprises:
selecting a processor for executing one or more payload applications;
selecting at least one hardware device; and
selecting at least one system bus for communicating data between the processor and the at least one hardware device.

18. The method of claim 12, wherein providing service from a infrastructure services layer includes providing one or more of, error handling, exception handling, diagnostics, logging, threading, thread protection and mutual exclusion services.

19. The method of claim 12, wherein providing services from a bus abstraction layer includes providing one or more of system bus initialization, system bus query services, and system bus discovery services.

20. The method of claim 12, wherein providing services from a device abstraction layer includes providing one or more of managing device initializations, managing communication sessions, mutual device exclusion services, and device discovery.

21. A method for communicating data between an embedded payload application a hardware device coupled to a processor through at least one system bus, the method comprising:
sending at least one function call from a payload application to a device driver associated with a hardware device;
sending at least one function call from the device driver to a device abstraction layer to establish a communications session between the device driver and the hardware device;
sending at least one function call from the device abstraction layer to a bus abstraction layer requesting initialization of a system bus coupled to the hardware device;
sending at least one function call to an infrastructure services layer requesting an infrastructure service;
establishing a communications session between the hardware device and the device driver; and
maintaining related session states associated with the communications session for as long as the payload application requires access to the hardware device.
